(19) United States
(12) Patent Application Publication
(10) Pub. No.: US 2010/0206670 A1
(43) Pub. Date: Aug. 19, 2010

(54) Guide Wheel Assembly

(75) Inventors: Robert Schroeder, Machesney Park, IL (US); Ming Sun, Crystal Lake, IL (US)

Correspondence Address: REINHART BOERNER VAN DEUREN P.C., 2215 PERRYGREEN WAY, ROCKFORD, IL, 61107, US

(73) Assignee: PACIFIC BEARING COMPANY, Rockford, IL (US)

(21) Appl. No.: 12/388,970

(22) Filed: Feb. 19, 2009

(51) Int. Cl. B66B 7/04

(52) U.S. Cl. 187/410

(57) ABSTRACT

A guide wheel assembly for a carriage of a guide system is provided. The guide wheel assembly includes guide wheel and a stud shaft. The stud shaft operably supports the guide wheel for rotation about a guide wheel axis. The stud shaft includes a tool engagement section. The tool engagement section has a generally cylindrical periphery and includes a plurality of angularly spaced apart flats formed in the cylindrical periphery. Adjacent ones of the flats are separated by an arcuate section of the cylindrical periphery. The stud shaft may also include a locating pilot region for locating the stud shaft within a bore of a device to which the guide wheel assembly is mounted.

### FIELD OF THE INVENTION

This invention generally relates to guided motion technology, and more particularly to guide wheels for use in guided motion technology.

### BACKGROUND OF THE INVENTION

Many processes use guided motion technology to provide accurate repeatable motion of devices. Typically, the guided motion technology will utilize a carriage that is guided along a guide rail. An object, for example a milling machine, x-ray machine, etc. will be mounted to the carriage and thus the object can travel along the path defined by the guide rail. The carriage will include guide wheels that directly interact with the guide rail and reduce friction therebetween to improve the motion of the carriage along the guide rail.

Because the guide wheels may be exposed to enormous numbers of cycles and potentially wear, in many implementations, the guide wheels are releasably mounted to the carriage so as to allow for replacement of the guide wheels. Typically, the guide wheel will include some form of a tool engaging structure that allows the user to engage the guide wheel to disengage it from the carriage. Typically, this is done by unthreading a threaded shaft of the guide wheel from the carriage or removing a nut connected to a threaded shaft of the guide wheel.

The present invention relates to improvements in the current state of the art for guided motion technology and particularly guide wheels for use in guided motion technology.

### BRIEF SUMMARY OF THE INVENTION

The present invention provides a new and improved guide wheel assembly. More particularly, in one embodiment, the present invention provides a new and improved guide wheel assembly that reduces the amount of material required for the stud shaft of the guide wheel. In another embodiment, the present invention provides a new and improved guide wheel assembly that improves the ability to locate a guide wheel relative to a device to which the guide wheel is attached.

In that respect, in one embodiment, a guide wheel assembly includes guide wheel and a stud shaft. The stud shaft operably supports the guide wheel for rotation about a guide wheel axis. The stud shaft includes a tool engagement section. The tool engagement section has a generally cylindrical periphery and includes a plurality of angularly spaced apart flats formed in the cylindrical periphery. Adjacent ones of the flats are separated by an arcuate section of the cylindrical periphery.

In one particular embodiment, the diameter of the tool engagement section is minimized but maintains the surface area of an abutment face of the engagement section. In that respect, the tool engagement section axially terminates on one axial end with an abutment face. The abutment face is bounded by an edge. The edge has a circular profile having a first diameter. The arcuate sections define a second diameter for the cylindrical periphery. The second diameter is greater than the first diameter. Further yet, in an other embodiment, the flats are tangent to the edge of the abutment face.

In another embodiment, the guide wheel assembly provides for improved location relative to an external device to which the guide wheel assembly is mounted. More particularly, the location of the guide wheel is not provided by a threaded section of the stud shaft of the guide wheel assembly, but is provided by a machined cylindrical region. To that effect, the guide wheel assembly includes a guide wheel and a stud shaft. The stud shaft operably supports the guide wheel for rotation about a guide wheel axis. The stud shaft includes a support region having a first diameter about which the guide wheel rotates. The support region defines the guide wheel axis. The stud shaft further includes a threaded portion having a second diameter for interacting with a cooperating set of threads of an external device. The stud shaft further includes a pilot region having a cylindrical periphery defining a third diameter. The first diameter is greater than the third diameter and the third diameter is greater than the second diameter.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective illustration of a representative carriage of a guide system including guide wheel assemblies according to the teachings of the present invention;

FIG. 2 is an exploded illustration of a guide wheel assembly according to an embodiment of the present invention;

FIG. 3 is a side view illustration of the carriage of FIG. 1;

FIG. 4 is a front view of an embodiment of a guide wheel assembly according to the teachings of the present invention;

FIG. 5 is a rear view of the guide wheel assembly of FIG. 4;

FIG. 6 is a left side view of the guide wheel assembly of FIG. 4

FIG. 7 is a top view of the guide wheel assembly of FIG. 4;

FIG. 8 is a top perspective view of the guide wheel assembly of FIG. 4;

FIG. 9 is another top perspective view of the guide wheel assembly of FIG. 4;

FIGS. 10-13 are front and top perspective views of additional embodiments of guide wheel assemblies according to the teachings of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

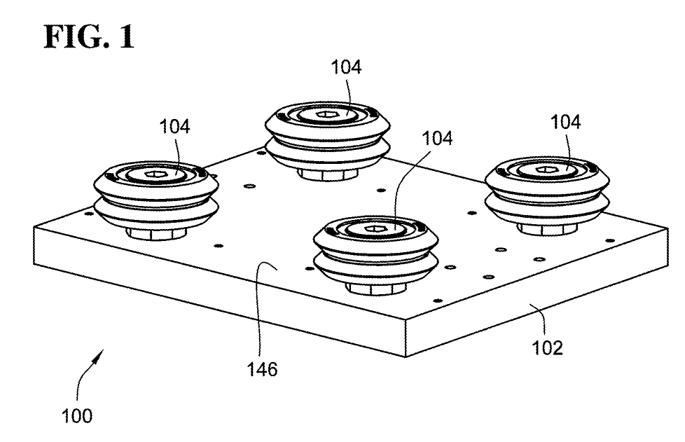

FIG. 1 illustrates a representative carriage 100 according to the teachings of the present invention. The carriage 100 includes a base plate 102 and a plurality of guide wheel assemblies 104 mounted to the base plate 102. The carriage 100 will travel along a guide rail to effectuate guided motion of the carriage 100 a long a path defined by the guide rail. A device, as explained previously, will be attached to the carriage for precise guided motion.

While the invention will be described in terms of being used with a carriage 100, alternative embodiments of guide wheel assemblies 104 according to the present invention may be mounted to directly to the device and be free of an intermediate base plate 102.

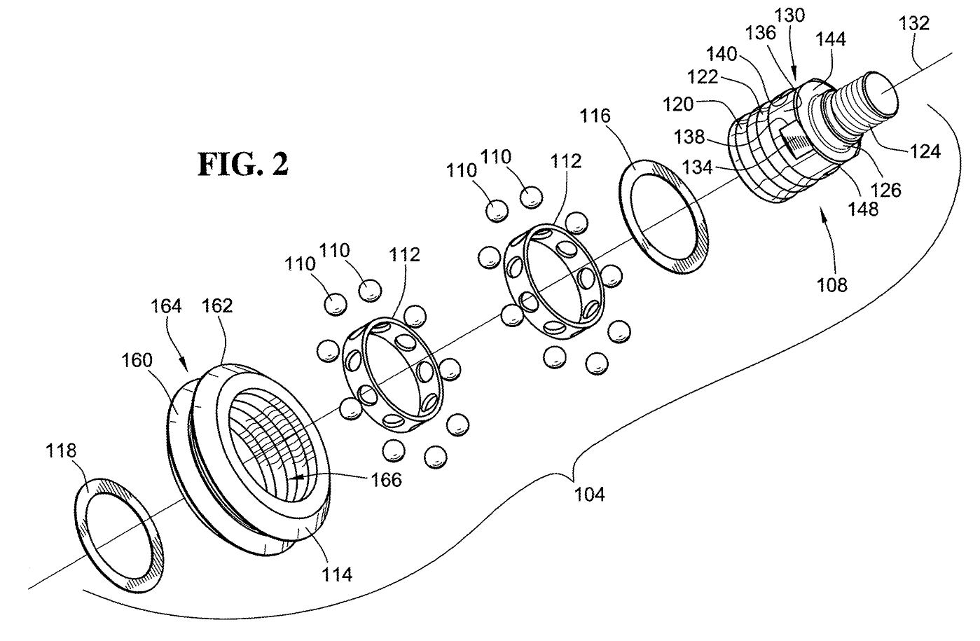

A representative guide wheel assembly 104 is illustrated in FIG. 2 in exploded form. The guide wheel assembly 104 generally includes a stud shaft 108, a plurality of all bearing balls 110 carried by bearing ball cages 112, a guide wheel 114 and a pair of shields 116, 118. The components combine to form the guide wheel assembly 104 that provides for precise and smooth movement along a guide rail.

The stud shaft 108 is a generally cylindrical body. The stud shaft 108 includes two raceways 120, 122 circumscribe the cylindrical body forming part of a wheel support section. The raceways 120, 122 receive the bearing balls 110 and act as an inner race for the bearing balls 110. When assembled, one set of the bearing balls 110 is located within each of the raceways 120, 122.

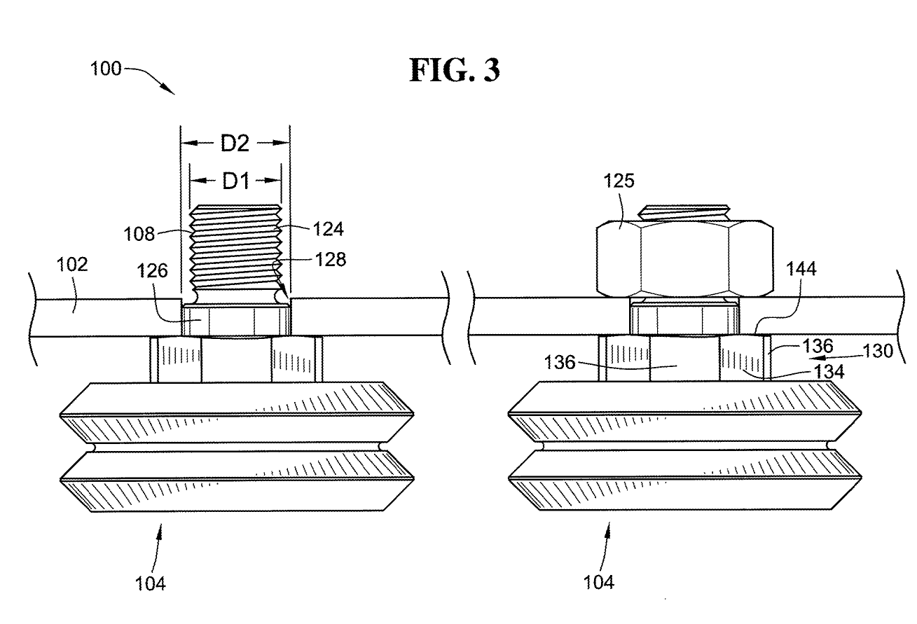

The stud shaft 108 further includes an integral threaded end 124. The threaded end 124 is used to secure the guide wheel assembly 104 to a carriage or device. The threaded end 124 may be directly threaded into cooperating threads of the carriage or device. Alternatively, the threaded end 124 may pass through the carriage or device from one side and then have a nut 125 (see FIG. 3) secured thereto on the other side of the carriage 100 or device to secure the stud shaft 108, and consequently the guide wheel assembly 104, thereto. Further yet, in an alternative embodiment, the threaded section could be an internally threaded section.

In a preferred embodiment, the stud shaft 108 includes a pilot 126 used to locate the stud shaft 108, and consequently the guide wheel assembly 104, when mounting the guide wheel assembly 104 to a base plate 102. As illustrated in FIG. 3, two guide wheel assemblies 104 are mounted to base plate 102. In the illustrated embodiment of the guide wheel assemblies 104, the diameter D1 of the threaded portion 124 is smaller than the diameter D2 of the pilot portion 126. The diameter D2 of the pilot portion 126 is substantially equal to the diameter of the aperture 128 in the base plate 102 through which the stud shaft 108 of the guide wheel assembly 104 passes.

This arrangement provides a benefit over other stud shaft designs, although is not required by all embodiments of the present invention. By including pilot 126, which is effectively a stepped cylindrical region of the outer surface or periphery of the stud shaft 108, the stud shaft 108 can be accurately located relative to base plate 102 or other devices to which the guide wheel assembly 104 is mounted. In the past, when stud shafts failed to include the pilot portion 126, the stud shaft 108 would be located within the aperture 128 based on the outer diameter of the threaded region 124. However, the threaded region 124 is susceptible to increased wear as well as increased tolerance variation due to the threads that are present in the threaded region 124. For example, by locating the stud shaft 108 based on the threaded region 124, the point of the threads will be engaging the wall defining aperture 128. In this arrangement, less surface area of the stud shaft 108 will be in contact with the wall defining aperture 128 and thus have less material upon potential wear. Further, the threads are inherently weaker than a cylindrical section of the stud shaft 108 and therefore were susceptible to damage such as pitting, denting, etc., thereby further reducing accuracy for locating the guide wheel assemblies 104 relative to the base plate 102. Finally, due to the excessive amount of machining to form the threads, the accuracy of the outer-diameter of the threaded portion 124 is less than the outer diameter of a constant cylindrical portion such as pilot portion 126, if not at least more difficult to maintain.

Thus, in the embodiment of FIG. 3, the threaded region 124 is strictly used to engage a nut 125 to secure the guide wheel assembly 104 to the base plate 102, while the pilot portion 126 is used to locate the stud shaft 108 relative to base plate 102.

To facilitate mounting the guide wheel assemblies 104 to a base plate 102 or other device, the stud shaft 108 includes a tool engagement region 130. The tool engagement region 130 permits a user to engage the stud shaft 108 with a tool so that the stud shaft can be rotated or prevented from rotating while mounting the guide wheel assembly 104 to the base plate 102 or other device. In the illustrated embodiment, the tool engagement region is formed in the outer cylindrical periphery of the stud shaft 108 and is engageable, during use, by a wrench or other device in a direction extending generally transverse to the axis 132 of the stud shaft 108 about which the threads of the threaded portion 124 are formed. It is preferred for the tool engagement region 130 to include only four flats 134, with each flat being equally angularly spaced apart from each other by 90 degrees. In other words, the flats 134 form two pairs of opposed flats with each pair being angularly spaced apart by 90 degrees. However, numbers of flats 134 may included in other embodiments.

Further, adjacent ones of flats 134 are spaced apart by arcuate sections 136 of the cylindrical periphery of the stud shaft 108. The arcuate sections 136 are interposed between and angularly defined by a first edge 138 of one of the adjacent flats 134 formed by the intersection of a first side of the flat 134 with the cylindrical periphery of the stud shaft 108 and a second edge 140 of the other one of the adjacent flats 134 formed by the intersection of a second side of the other one of the flats 134 with the cylindrical periphery of the stud shaft 108. Thus, a given flat 134 is defined between first and second edges 138, 140 that are formed by the intersection of opposed sides of the flats 134 intersecting the cylindrical periphery of the stud shaft 108. Typically, these flats 134 are machined into the cylindrical periphery of the stud shaft 108.

In a preferred embodiment, the chord angle α between the first and second edges 138, 140 of flats 134 relative to the central axis 142 defining the cylindrical periphery of the stud shaft 108 is less than or about equal to the arc angle β of the arcuate portions 136. In this arrangement, the tool engagement region 130 approximates an octagonal region having four sides defined by flats 134 and four sides generally defined by arcuate sections 136, with alternating sides being flats 134 and arcuate sections 136. Thus, this allows for increasing the amount of surface area of an end face 144 that abuts a face 146 of base plate 102 (see FIG. 3), thereby providing increased engagement between the end face 144 and the base plate 102.

Further, in a preferred embodiment, the stud shaft 108 includes a chamfered or bullnose end 148 such that end face 144 has a smaller diameter D3 than the diameter D4 of the cylindrical periphery defined by the arcuate sections 136. Further, in an even more preferred embodiment, the flats 134 are formed as tangents to the edge 145 of the end face 144 such that the inclusion of the flats 134 does not reduce the amount of surface area of end face 144. Thus, the spacing between opposed flats 134 in a pair of flats is equal to the diameter D3 of the end face 144. This arrangement maintains the maximum amount of area permissible to interact with face 146 of base plate 102.

Thus, it is further desired to minimize the amount of chamfer, i.e. the difference between diameter D3 and diameter D4 so as to avoid excess material, while maintaining a desired amount of end face 144 area. Thus, to minimize the amount of chamfer, it is desirable in one embodiment to have the difference between diameter D3 and diameter D4 such that chord angle α is less than or equal to arc angle β, while maintaining the tangent orientation between the flats 134 and edge 145 of end face 144.

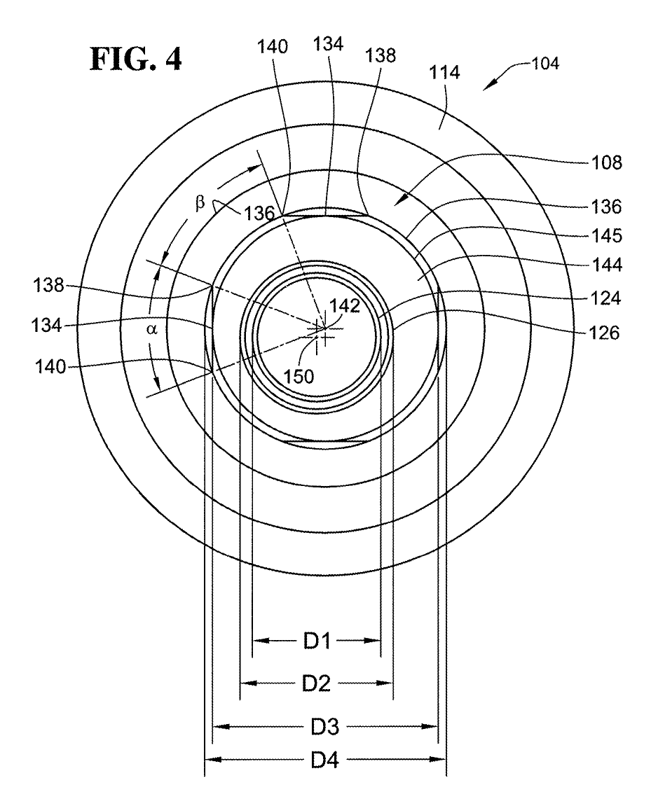

As illustrated in FIG. 4, in a preferred embodiment, the threaded portion 124 and pilot portion 126 are coaxial about offset mounting axis 150 that is radially offset from central axis 142 of the stub shaft 108. In this arrangement, the guide wheel 114 is concentric with and rotates about central axis 142 of the stub shaft 108. However, as the stub shaft 108 is rotated angularly about offset mounting axis 150 of the threaded portion 124 and pilot portion 126, depending on the mounting arrangement, the relative position of the guide wheel is adjusted due to its axis, central axis 142, being radially offset therefrom. This configuration allows for precisely adjusting the interaction of the guide wheel assembly 104, and the guide wheel 114 particularly, relative to a guide rail upon which it travels.

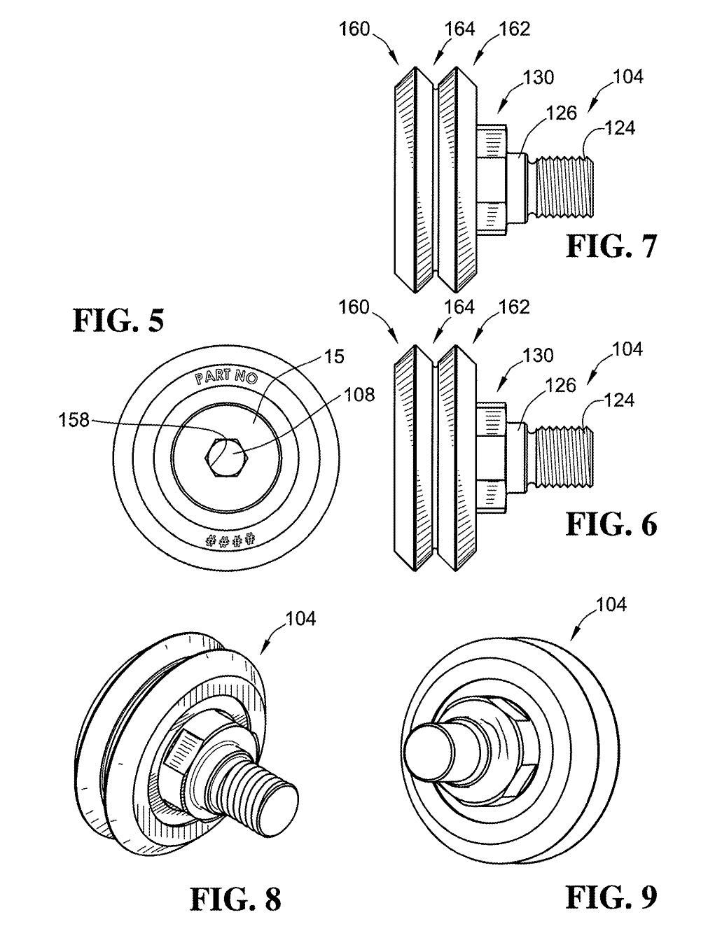

The stub shaft 108 may also include a second tool engagement section 156. In the illustrated embodiments, as illustrated in FIG. 5, second tool engagement section 156 is provided by an axial bore formed in an end of stub shaft 108. This bore includes flats 158 that are engageable with a tool such as an hex wrench, torx wrench, square bit, phillips screw driver, etc. In the illustrated embodiment, the flats 158 form a hexagonal shape and are most typically engageable by a properly sized Allen wrench. In FIG. 5, “PART NO and ####” are optionally included and need not be included in all embodiments.

As illustrated in FIGS. 2 and 6, the preferred guide wheels 114 have a W profile The W profile has two v-shaped regions 160, 162 that are axially aligned forming a channel 164 therebetween. The guide wheels 114 also define a through bore 166 through which the stud shaft 108 extends when the guide wheel assembly 104 is assembled.

With reference to FIG. 2, the inner surface of the bore 166 includes two raceways 170, 172 that circumscribe the bore 166. The raceways 170, 172 receive the bearing balls 110 and act as an outer race for the bearing balls 110. When assembled, one set of the bearing balls 110 is located within each of the raceways 120, 122.

The bearing balls 110 are held together and spaced apart angularly by cage 112. The cage 112 keeps the bearing balls 110 from being removed from being between the inner and outer raceways.

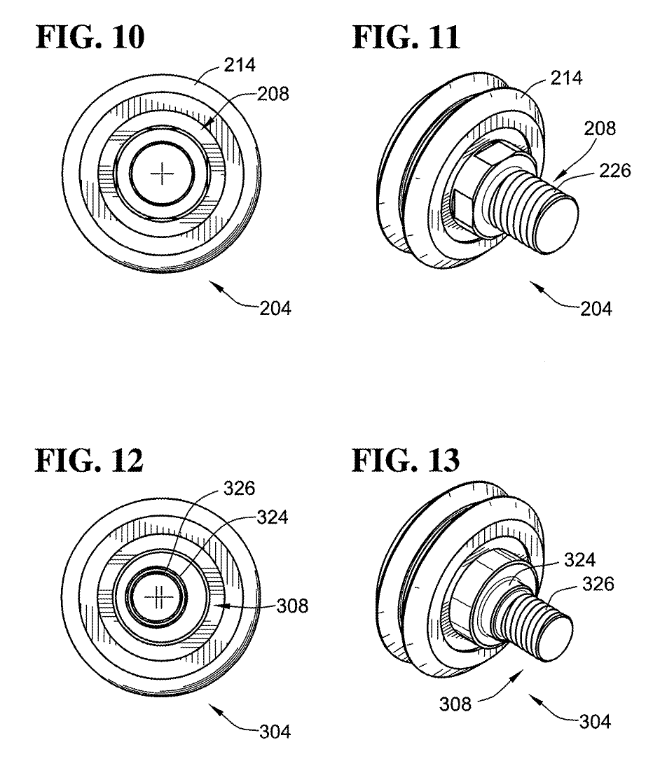

Alternative embodiments of the guide wheel assemblies are illustrated in FIGS. 10-13.

FIGS. 10 and 11 illustrate a further embodiment of a guide wheel assembly 204 that is free of the pilot section. In this embodiment, the threaded portion 226 is generally coaxial with the rest of stud shaft 208 and guide wheel 214.

FIGS. 12 and 13 illustrate a further embodiment of a guide wheel assembly 304. In this embodiment, the pilot section 324 and threaded portion 326 are offset from the rest of the stud shaft 308 and the guide wheel 314. However, the guide wheel assembly is free of a tool engagement region such as tool engagement region 130 of the prior embodiments.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A guide wheel assembly comprising:
a guide wheel; and
a stud shaft operably supporting the guide wheel for rotation about a guide wheel axis, the stud shaft including a tool engagement section, the tool engagement section having a generally cylindrical periphery and including a plurality of angularly spaced apart flats formed in the cylindrical periphery; adjacent ones of the flats being separated by an arcuate section of the cylindrical periphery.

2. The guide wheel assembly of claim 1, wherein a arc angle of the arcuate sections is equal to or greater than an chord angle of the flats relative to a common vertex.

3. The guide wheel assembly of claim 1, wherein the tool engagement section axially terminates on one axial end with an abutment face, the abutment face being bounded by an edge, the edge having a circular profile having a first diameter, the arcuate sections defining a second diameter for the cylindrical periphery, the second diameter being greater than the first diameter.

4. The guide wheel assembly of claim 3, wherein an arc angle of the arcuate sections is equal to or greater than a chord angle of the flats relative to a common vertex.

5. The guide wheel assembly of claim 3, wherein the flats are tangent to the edge.

6. The guide wheel of claim 5, wherein the plurality of flats includes four flats and the cylindrical periphery includes four arcuate sections.

7. The guide wheel of claim 5, wherein the flats are tangent to the edge.

8. The guide wheel of claim 5, further including threaded section, the tool engagement section being axially interposed between the guide wheel and threaded section; the abutment face facing the threaded section.

9. The guide wheel of claim 8, further including a cylindrical pilot region axially interposed between the threaded section and the abutment face, the pilot region having a third diameter and the threaded section having a fourth diameter, the third diameter being less than the first diameter and greater than the fourth diameter.

10. The guide wheel assembly of claim 9, wherein the pilot region and threaded section being concentric about a mounting axis, the mounting axis being offset from the guide wheel axis such that the cylindrical periphery of the tool engagement section and the pilot region are not concentric.

11. A guide wheel assembly comprising:
a guide wheel;
a stud shaft operably supporting the guide wheel for rotation about a guide wheel axis, the stud shaft including a support region having a first diameter about which the guide wheel rotates, the support region defining the guide wheel axis, the stud shaft further including a threaded portion having a second diameter for interacting with a cooperating set of threads, the stud shaft further including a pilot region having a cylindrical periphery defining a third diameter;
wherein the first diameter is greater than the third diameter and the third diameter is greater than the second diameter.

12. The guide wheel assembly of claim 11, wherein the threaded portion and the pilot region are co-axial.

13. The guide wheel assembly of claim 11, wherein the pilot region is axially interposed between the support region and the threaded portion.

14. The guide wheel assembly of claim 13, wherein the threaded portion and the pilot region are co-axial.

15. The guide wheel assembly of claim 14, wherein the threaded portion and the pilot region are co-axial about a mounting axis, the mounting axis and the guide wheel axis being offset from one another.

16. The guide wheel assembly of claim 14, wherein the threaded portion and the pilot region are co-axial about a mounting axis, the mounting axis and the guide wheel axis being coaxial.

17. The guide wheel assembly of claim 4, further including a tool engagement section is a section of the stud shaft that defines a generally cylindrical periphery that also includes at least one feature engageable by a tool for rotating the tool about an axis that is parallel to the guide wheel axis, the tool engagement section being axially interposed between the pilot region and the support region.

18. The guide wheel assembly of claim 17, wherein the general cylindrical periphery has a fourth diameter equal to the first diameter.
